(19) United States
(12) Patent Application Publication
(10) Pub. No.: US 2025/0119973 A1
(43) Pub. Date: Apr. 10, 2025

(54) METHOD AND APPARATUS FOR TCI STATE UPDATE IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 18/775,021

(22) Filed: Jul. 17, 2024

(30) Foreign Application Priority Data
Oct. 6, 2023 (KR) 1020230133155

(51) Int. Cl. H04W 76/20; H04W 24/10; H04W 36/08; H04W 80/02

(52) U.S. Cl. CPC H04W 76/20; H04W 24/10; H04W 36/08; H04W 80/02

(57) ABSTRACT

A technique for managing TCI states in conjunction with LTM operations is provided. The technique comprises first updating of activated TCI states for a cell based on a first type TCI state activation/deactivation MAC CE, final updating of TCI states for the cell based on a LTM cell switch command MAC CE and subsequent updating of TCI states for the cell based on a second type TCI state activation/deactivation MAC CE.

### CROSS-REFERENCE TO RELATED APPLICATION

This application claims priority to and the benefit of Korean Patent Application No. 10-2023-0133155, filed on Oct. 6, 2023, the disclosure of which is hereby incorporated herein by reference in its entirety.

### BACKGROUND

### Technical Field

The present disclosure relates to performing TCI state update in wireless mobile communication system.

### Related Art

To meet the increasing demand for wireless data traffic since the commercialization of 4th generation (4G communication systems), the 5th generation (5G system) is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency.

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility.

To meet the strict service requirements for the future mobile communication system, new mobility mechanism with less interruption time is required.

### SUMMARY

Aspects of the present disclosure are to address the problems of TCI updates around LTM procedure. The method of the terminal includes receiving a radio resource control (RRC) reconfiguration message, transmitting a layer 1 measurement report based on the layer 1 measurement report configuration, receiving a MAC CE comprising information on one or more transmission configuration indication (TCI) states, determining a specific cell to apply the one or more TCI states and applying the one or more TCI states to the specific cell.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 1C is a diagram illustrating L1/L2 triggered mobility procedure.

FIG. 1D is a diagram illustrating TCI state update.

FIG. 2A is a diagram illustrating operations of a terminal and a base station according to an embodiment of the present invention.

FIG. 2B is a diagram illustrating format of type 1 TCI state activation/deactivation MAC CE.

FIG. 2C is a diagram illustrating format of type 2 TCI state activation/deactivation MAC CE.

FIG. 2D is a diagram illustrating format of LTM Cell Switch Command MAC CE.

FIG. 3 is a flow diagram illustrating an operation of a terminal.

FIG. 4A is a block diagram illustrating the internal structure of a UE to which the disclosure is applied.

FIG. 4B is a block diagram illustrating the configuration of a base station according to the disclosure.

### DETAILED DESCRIPTION

Hereinafter, embodiments of the present invention will be described in detail with reference to the accompanying drawings. In addition, in the description of the present invention, if it is determined that a detailed description of a related known function or configuration may unnecessarily obscure the gist of the present invention, the detailed description thereof will be omitted. In addition, the terms to be described later are terms defined in consideration of functions in the present invention, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present invention, “trigger” or “triggered” and “initiate” or “initiated” can be used interchangeably.

In the present invention, UE and terminal can be used interchangeably. In the present invention, NG-RAN node and base station and GNB can be used interchangeably.

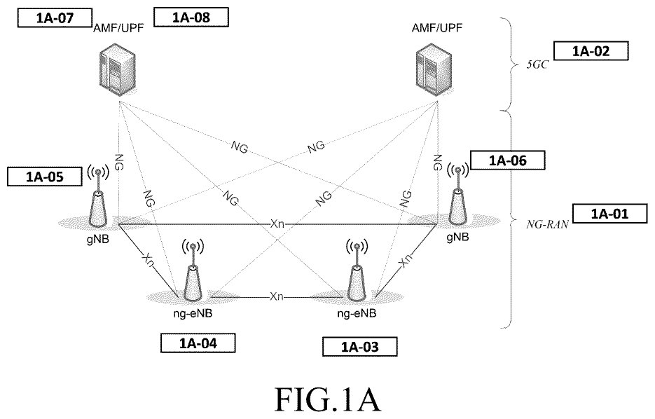

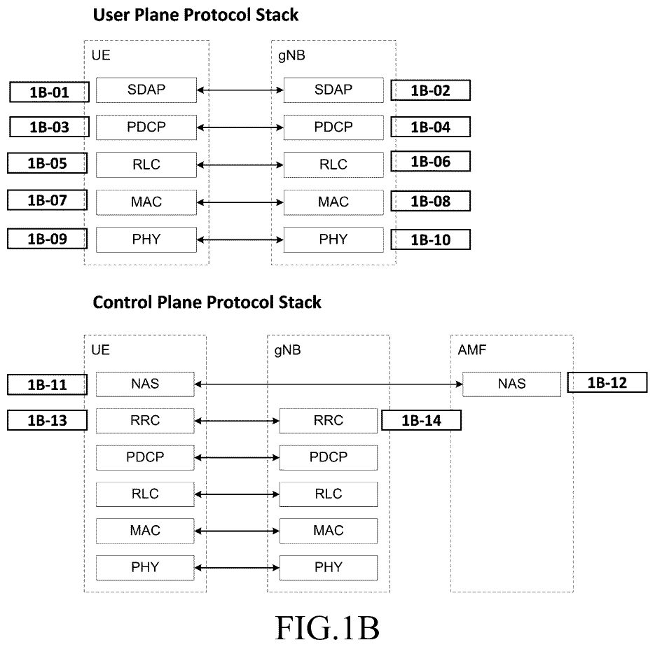

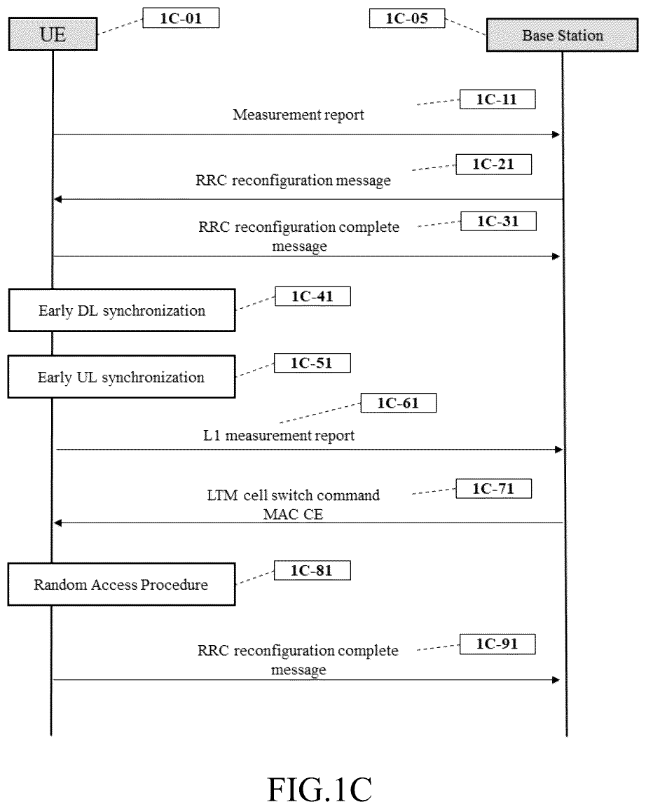

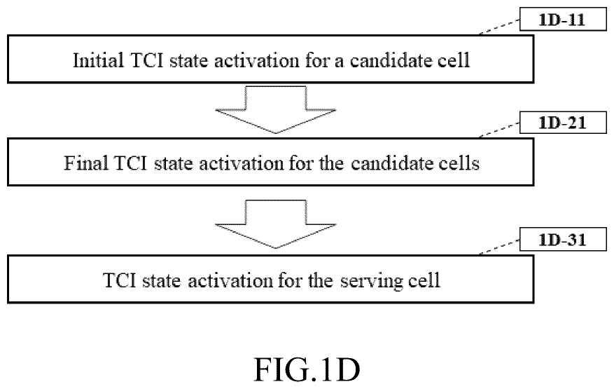

FIG. 1A is a diagram illustrating the architecture of an 5G system and a NG-RAN to which the disclosure may be applied.

5G system consists of NG-RAN 1A-01 and 5GC 1A-02. An NG-RAN node is either:
a GNB, providing NR user plane and control plane protocol terminations towards the UE; or
an ng-eNB, providing E-UTRA user plane and control plane protocol terminations towards the UE.

The GNBs 1A-05 or 1A-06 and ng-eNBs 1A-03 or 1A-04 are interconnected with each other by means of the Xn interface. The GNBs and ng-eNBs are also connected by means of the NG interfaces to the 5GC, more specifically to the AMF (Access and Mobility Management Function) and to the UPF (User Plane Function). AMF 1A-07 and UPF 1A-08 may be realized as a physical node or as separate physical nodes.

A GNB 1A-05 or 1A-06 or an ng-eNBs 1A-03 or 1A-04 hosts the functions listed below.

Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and
Radio access network sharing; and
Tight interworking between NR and E-UTRA; and
Support of Network Slicing.

The AMF 1A-07 hosts the functions such as NAS signaling, NAS signaling security, AS security control, SMF selection, Authentication, Mobility management and positioning management.

The UPF 1A-08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B-01 or 1B-02, PDCP 1B-03 or 1B-04, RLC 1B-05 or 1B-06, MAC 1B-07 or 1B-08 and PHY 1B-09 or 1B-10. Control plane protocol stack consists of NAS 1B-11 or 1B-12, RRC 1B-13 or 1B-14, PDCP, RLC, MAC and PHY.

Each protocol sublayer performs functions related to the operations listed below.

NAS: authentication, mobility management, security control etc

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

The terminal supports three RRC states.

RRC_IDLE state can be characterized with followings:
PLMN selection; Broadcast of system information;
Cell re-selection mobility;
Paging for mobile terminated data is initiated by 5GC;
DRX for CN paging configured by NAS.
RRC_INACTIVE state can be characterized with followings:
PLMN selection; Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for UE;
The UE AS context is stored in NG-RAN and the UE;
NG-RAN knows the RNA which the UE belongs to.
RRC_CONNECTED state can be characterized with followings:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Network controlled mobility including measurements.

Mobility is a key feature in mobile communications system. Conventional mobility feature relies on L3 measurements and L3 signaling, which may incur long delay and service interruption. To meet the strict service requirements for the future mobile communication system, L1/L2 Triggered Mobility (LTM) is introduced.

FIG. 1C illustrates the overall procedure for LTM.

LTM is a procedure in which a GNB receives L1 measurement report(s) from a UE, and on their basis the GNB changes UE serving cell by a cell switch command signalled via a MAC CE. The cell switch command indicates an LTM candidate configuration that the GNB previously prepared and provided to the UE through RRC signalling. Then the UE switches to the target configuration according to the cell switch command.

When configured by the network, it is possible to activate TCI states of one or multiple cells that are different from the current serving cell. For instance, the TCI states of the LTM candidate cells can be activated in advance before any of those cells become the serving cell. This allows the UE to be DL synchronized with those cells, thereby facilitating a faster cell switch to one of those cells when cell switch is triggered.

When configured by the network, it is possible to initiate UL TA acquisition (called early TA) procedure of one or multiple cells that are different from the current serving cells. If the cell has the same N_{TA} as the current serving cells or N_{TA}=0, early TA acquisition procedure is not required. The network may request the UE to perform early TA acquisition of a candidate cell before a cell switch. The early TA acquisition procedure is triggered by PDCCH order. The GNB/GNB-DU to which the candidate cell belongs calculates the TA value and sends it to the GNB/GNB-DU to which the serving cell belongs via GNB-CU. The serving cell sends the TA value in the LTM cell switch command MAC CE when triggering LTM cell switch.

Depending on the availability of a valid TA value, the UE performs either a RACH-less LTM or RACH-based LTM cell switch. If the valid TA value is provided in the cell switch command, the UE applies the TA value as instructed by the network. In the case where UE-based TA measurement is configured, but no valid TA value is provided in the cell switch command, the UE applies the valid TA value by itself if available. Meanwhile, the UE performs RACH-less LTM cell switch upon receiving the cell switch command. If no valid TA value is available, the UE performs RACH-based LTM cell switch.

Regardless of whether the UE is configured for UE-based TA measurement for a certain candidate cell, it will still follow the PDCCH order, which includes requesting a random access procedure towards the candidate cells. This also applies to the candidate cells for which the UE is capable of deriving TA values by itself. Additionally, regardless of whether the UE has already performed a random access procedure towards the candidate cells, it will still follow the UE-based measurement configuration if configured by the network.

For RACH-less LTM, the UE accesses the target cell using either a configured grant or a dynamic grant. The configured grant is provided in the LTM candidate configuration, and the UE selects the configured grant occasion associated with the beam indicated in the cell switch command. Upon initiation of LTM cell switch to the target cell, the UE starts to monitor PDCCH on the target cell for dynamic scheduling. Before RACH-less LTM procedure completion, the UE shall not trigger random access procedure if it does not have a valid PUCCH resource for triggered SRs.

The following principles apply to LTM:
Security keys are maintained upon an LTM cell switch;
Subsequent LTM is supported.

The overall procedure for LTM is as followings. Before LTM procedure is initiated, UE and GNB performs data transfer based on activated TCI states. GNB may use type 1 TCI state activation/deactivation MAC CE to activate TCI states when LTM procedure is not ongoing.

The UE sends a MeasurementReport message to the GNB. The GNB decides to configure LTM and initiates LTM preparation 1C-11.

The GNB transmits an RRCReconfiguration message to the UE including the LTM candidate configurations 1C-21.

The UE stores the LTM candidate configurations and transmits an RRCReconfigurationComplete message to the GNB 1C-31.

The UE performs early DL synchronization with the LTM candidate cell(s) before receiving the cell switch command 1C-41. The UE may activate and deactivate TCI states of LTM candidate cell(s), as triggered by the GNB. For this operation, type 2 type 2 TCI state activation/deactivation MAC CE is used. Apart from the early DL synchronization with the LTM candidate cell, GNB may use type 1 TCI state activation/deactivation MAC CE to active TCI states of serving cells.

The UE may perform early UL synchronization with LTM candidate cell(s) 1C-51 before receiving the cell switch command, by using UE-based TA measurement, if configured, and/or by transmitting a preamble towards the candidate cell, as triggered by the GNB. UE performs early TA acquisition with the candidate cell(s) as requested by the network before receiving the cell switch command.

The UE performs L1 measurements on the configured LTM candidate cell(s) and transmits L1 measurement reports to the GNB 1C-61.

The GNB decides to execute cell switch to a target cell and transmits an LTM cell switch command MAC CE 1C-71 triggering cell switch by including a target configuration ID which indicates the index of the candidate configuration of the target cell, a beam indicated with a TCI state or beams indicated with DL and UL TCI states, and a timing advance command for the target cell. The UE switches to the target cell and applies the candidate configuration indicated by the target configuration ID.

The UE performs the random access procedure towards the target cell 1C-81, if UE does not have valid TA of the target cell.

The UE completes the LTM cell switch procedure by sending RRCReconfigurationComplete message to target cell 1C-91.

Subsequent LTM is done by repeating the early synchronization, LTM cell switch execution, and LTM cell switch completion steps without releasing other LTM candidate configurations after each LTM cell switch completion.

To perform early DL synchronization properly and efficiently, a type 2 TCI state activation/deactivation MAC CE is used.

Before, during and after LTM cell switch procedure, TCI states on various cells need to be updated. To facilitate efficient TCI state management, various types of MAC CEs are defined.

Activation of proper TCI states is crucial to achieve high quality of service in beam forming based system. In LTM operation, since many candidate cells are involved, it is important to activate TCI states of a candidate cell efficiently, properly and correctly. TCI state activation is not one-shot process but rather continuous process since the target TCI state to be activated is continuously changing.

For a candidate cell, TCI state is initially activated in the early DL synchronization step 1D-11. Based on LI measurement reports before LTM cell switch to the candidate cell is executed, GNB may determine the final TCI state for the candidate cell. GNB may indicate the final TCI state 1D-21 in the LTM Cell switch command MAC CE. After then, TCI states may be continuously updated for the serving cell (that is previously the candidate cell) 1D-31.

For the initial activation, final activation and continuous updates, GNB and UE performs TCI state updates based on various MAC CEs.

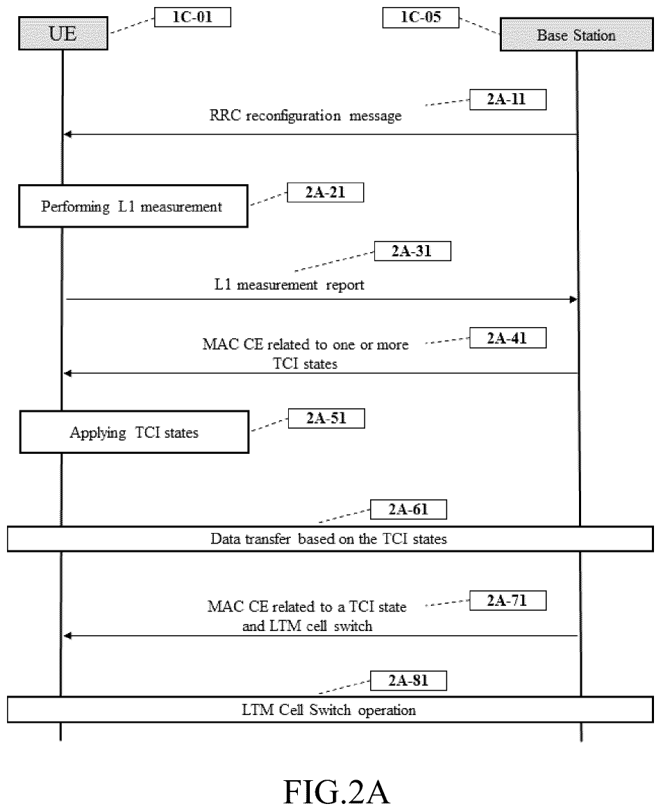

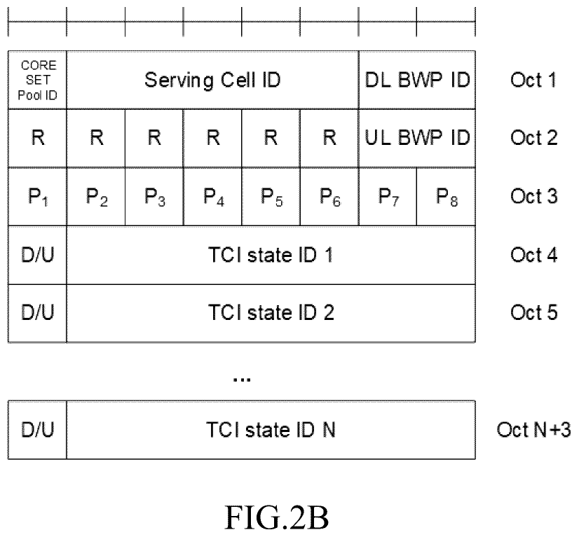

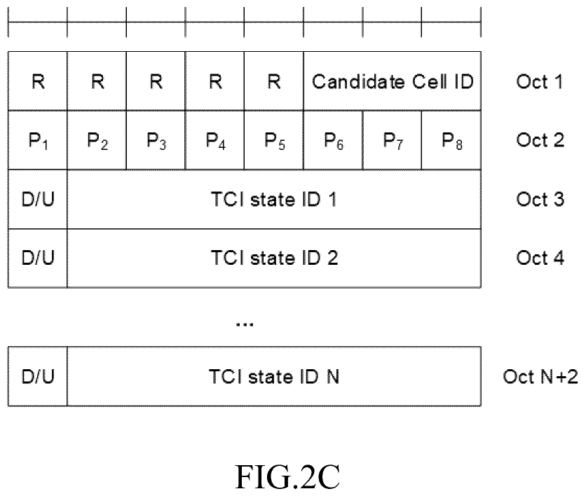

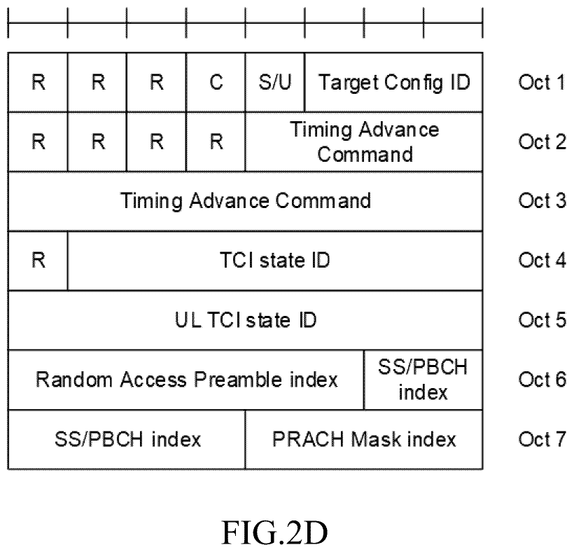

FIG. 2A illustrates operation of UE and GNB to manage TCI states based on various MAC CEs.

UE may receive from the base station a RRCReconfiguration including one or more LTM candidate configuration and L1 measurement report configuration 2A-11.

Based on the one or more LTM candidate cell configurations, UE may perform early downlink synchronization with LTM candidate cells. UE may perform downlink synchronization for a corresponding LTM candidate cell based on SpCellConfig of the LTM candidate cell configuration. Based on each of the one or more LTM candidate cell configurations, UE may perform early uplink synchronization with corresponding LTM candidate cell.

UE performs L1 measurement 2A-21.

UE transmits to the base station L1 measurement report based on the L1 measurement report configuration 2A-31.

UE receives from the base station a MAC CE that comprises one or more TCI states 2A-41.

UE may determine a cell for which the MAC CE applies for and apply the one or more TCI states 2A-51.

UE and base station perform data transfer based on the applied TCI states 2A-61.

UE receives from the base station a LTM Cell Switch Command MAC CE 2A-71.

UE performs LTM Cell Switch based on the LTM Cell switch command MAC CE 2A-81.

Each of the one or more LTM candidate configuration comprises following fields:
ltm-CandidateId field indicating an LTM candidate cell configuration;
ltm-CandidateConfig field comprising an RRCReconfiguration message used to configure an LTM candidate cell;
ltm-ConfigComplete field indicating whether the LTM candidate cell configuration within ltm-CandidateConfig is a complete configuration.

The RRCReconfiguration message in the ltm-CandidateConfig field comprises following IEs.
SpCellConfig; and
one or more ScellConfig
SpCellConfig IE comprises serving cell configuration for a special cell of the LTM candidate configuration. SCellConfig comprises serving cell configuration for secondary cell of the LTM candidate configuration.

UE performs LTM cell switch operation based on the LTM candidate configuration indicated by ltm-CandidateId.

The base station transmits to the UE dedicate reference signal called CSI-RS to evaluate the channel between the UE and the base station. UE measures the CSI-RS to derive signal quality such as RSRP or RSRQ. UE report the measurement result to the base station in layer 1 level. Since the measurement and reporting are performed in layer 1, the process is called layer 1 measurement and layer 1 measurement report.

L1 measurement report configuration is indicated by CSI-ReportConfig IE. CSI-ReportConfig IE comprises necessary parameters for reporting such as report configuration type, report quantity, PUCCH resource to be used for reporting and others.

Two types of MAC CE that contains one or more TCI states can be transferred between the base station and the UE. If the base station wishes to activate TCI states for one of current serving cells, base station transmits to the UE a type 1 TCI state activation/deactivation MAC CE. If the base station wishes to activate TCI states for one of special cells of candidate configurations, the base station transmits to the UE a type 2 TCI state activation/deactivation MAC CE.

The serving cell is cell where UE and the base station are currently performing data transfer. The serving cell comprises current special cell and current secondary cells.

Each candidate configuration is associated with a candidate special cell and one or more candidate secondary cells. UE and the base station do not perform data transfer in the candidate cells. After LTM cell switch to the candidate configuration, UE and the base station perform data transfer in the candidate cells.

FIG. 2B illustrates format of the type 1 TCI state activation/deactivation MAC CE

The type 1 TCI state activation/deactivation MAC CE comprises following fields:
Serving Cell ID: This field indicates the identity of the Serving Cell for which the MAC CE applies. The length of the field is 5 bits.
DL BWP ID: This field indicates a DL BWP for which the MAC CE applies. The length of the BWP ID field is 2 bits;
UL BWP ID: This field indicates a UL BWP for which the MAC CE applies. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields.
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as configured by RRC reconfiguration message.

FIG. 2C illustrates format of the type 2 TCI state activation/deactivation MAC CE.
Candidate Cell ID: This field indicates the identity of an LTM candidate configuration (e.g. RRCReconfiguration associated with the LTM-CandidateId) for which the MAC CE applies. UE applies the MAC CE to a cell that is determined based on the LTM candidate configuration indicated by LTM-CandidateId.
Pᵢ: This field indicates whether each TCI codepoint has multiple TCI states or a single TCI state. If the Pᵢ field is set to 1, the i^{th} TCI codepoint includes the DL TCI state and the UL TCI state. If the Pᵢ field is set to 0, the i^{th} TCI codepoint includes only the DL/joint TCI state or the UL TCI state. The codepoint to which a TCI state is mapped is determined by its ordinal position among all the TCI state ID field. A TCI codepoint comprises information on TCI state for downlink and TCI state for uplink. One or more TCI codepoints can be activated simultaneously.
D/U: This field indicates whether the TCI state ID in the same octet is for a joint/downlink or an uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId or TCI-UL-StateId as configured by a RRC reconfiguration mesage.
R: Reserved bit, set to 0.

FIG. 2D illustrates format of LTM Cell switch command MAC CE.
Target Configuration ID: This field indicates the index of candidate target configuration to apply for LTM cell switch, corresponding to ltm-CandidateId.
Timing Advance Command: This field indicates whether the TA is valid for the LTM target cell (i.e. the SpCell corresponding to the target configuration indicated by Target Configuration ID field). If the value of this field is set to FFF, this field indicates that no valid timing adjustment is available for the PTAG of the LTM target cell (and UE shall perform Random Access to the LTM target cell); Otherwise, this field indicates the index value T_{A} used to control the amount of timing adjustment that the MAC entity has to apply, and that the UE can skip the Random Access procedure for this LTM cell switch.
TCI state ID: This field indicates and activates the TCI state for the LTM target cell (i.e. the SpCell of the target configuration indicated by the Target Configuration ID field). The TCI state is identified by TCI-StateId. If the value of unifiedTCI-StateType in the SpCell of the target configuration indicated by Target Configuration ID field is joint, this field is for joint TCI state, otherwise, this field is for downlink TCI state. This field is included when the value of the Timing Advance Command field is not set to FFF.
UL TCI state ID: This field indicates and activates the uplink TCI state for the LTM target cell (i.e. the SpCell of the target configuration indicated by the Target Configuration ID field). The most significant bits of UL TCI state ID are considered as reserved bits and the remainder 6 bits indicate the TCI-UL-StateId. This field is included if the value of unifiedTCI-StateType in the SpCell corresponding to the target configuration indicated by Target Configuration ID field is separate and if the value of the Timing Advance Command field is not set to FFF.

TCI state is related to a beam direction (or quasi-colocation) and configured by a TCI state IE.

TCI state IE comprises following fields.

tci-StateId: This field indicates the identity of the tci-state.

refernceSignal: This field comprises either NZP-CSI-RS-ResourceId or SSB-Index

If a TCI state is activated for a downlink signal, UE receives the downlink signal based on the activated TCI state (e.g. with assumption of downlink beam direction associated with the TCI state).

If a TCI state is activated for a uplinik signal, UE transmits the uplink signal based on the activated TCI state (e.g. with assumption of uplink beam direction/uplink spatial filter associated with the TCI state).

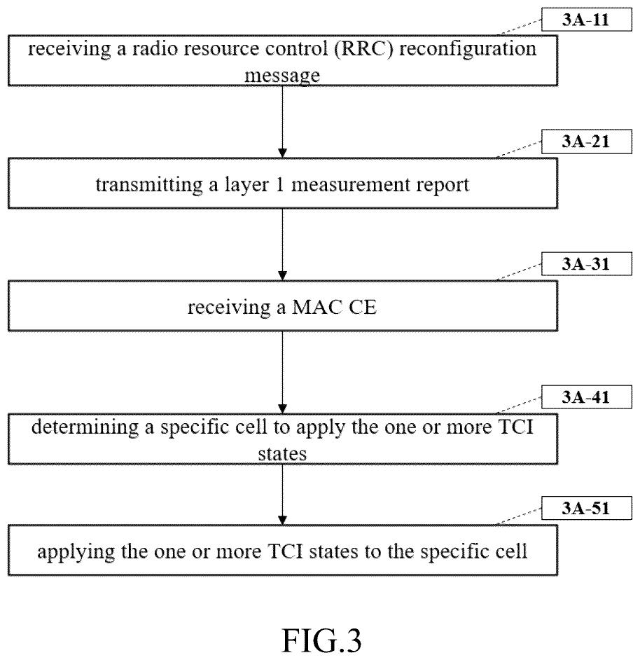

FIG. 3 illustrates UE operations. UE performs followings:
receiving a radio resource control (RRC) reconfiguration message, wherein the RRC reconfiguration message comprises a layer 1 measurement report configuration 3A-11;
transmitting a layer 1 measurement report based on the layer 1 measurement report configuration 3A-21;
receiving a MAC CE, wherein the MAC CE comprises information on one or more transmission configuration indication (TCI) states 3A-31;
determining a specific cell to apply the one or more TCI states 3A-41;
applying the one or more TCI states to the specific cell 3A-51.

In case that the MAC CE is Type 2 TCI state activation/deactivation MAC CE, UE first determine a candidate configuration based on the LTM-CandidateId field, and then determines that the specific cell is the specific cell of the candidate configuration. Special cell is Primary Cell (PCell) or Primary SCG Cell (PSCell).

In case that the MAC CE is Type 2 TCI state activation/deactivation MAC CE, UE determines the specific cell directly from the Serving Cell ID field of the Type 1 TCI state activation/deactivation MAC CE.

The Type 2 TCI state activation/deactivation MAC CE comprises:
LTM-CandidateId field that comprises information on candidate identifier; and
one or more TCI state identity fields, wherein each of the one or more TCI state identity fields comprises TCI state identity of TCI state to be activated.

Each of the one or more TCI state identity field is associated with a D/U field.

The D/U field indicates TCI state identity in associated TCI state identity field is for:
downlink TCI state in case that the D/U field indicates a first value; and
uplink TCI state in case that the D/U field indicates a second value.

The Type 1 TCI state activation/deactivation MAC CE comprises:
the Serving Cell ID field that comprises information on serving cell identifier; and
one or more TCI state identity fields, wherein each of the one or more TCI state identity fields comprises TCI state identity of TCI state to be activated.

Each of the one or more TCI state identity field is associated with a D/U field.

The D/U field indicates TCI state identity in associated TCI state identity field is for:
downlink TCI state in case that the D/U field indicates a first value; and
uplink TCI state in case that the D/U field indicates a second value.

The RRC reconfiguration message further comprises one or more candidate configurations.

Each of the one or more candidate configuration comprises:
a candidate identifier;
a special cell configuration; and
one or more secondary cell configurations.

The LTM Cell switch command MAC CE comprises:
a timing advance command field; and
a TCI state identity field

The UE performs lower layer triggered mobility (LTM) cell switch based on the LTM Cell switch command MAC CE.

TCI state indicated by the TCI state identity field is applied to LTM target cell.

TCI state indicated by the TCI state identity field is applied to:
a special cell of LTM candidate configuration in case that the TCI state identity field is comprised in the Type 2 TCI state activation/deactivation MAC CE; and
the LTM target cell in case that the TCI state identity field is comprised in the LTM Cell switch command MAC CE.

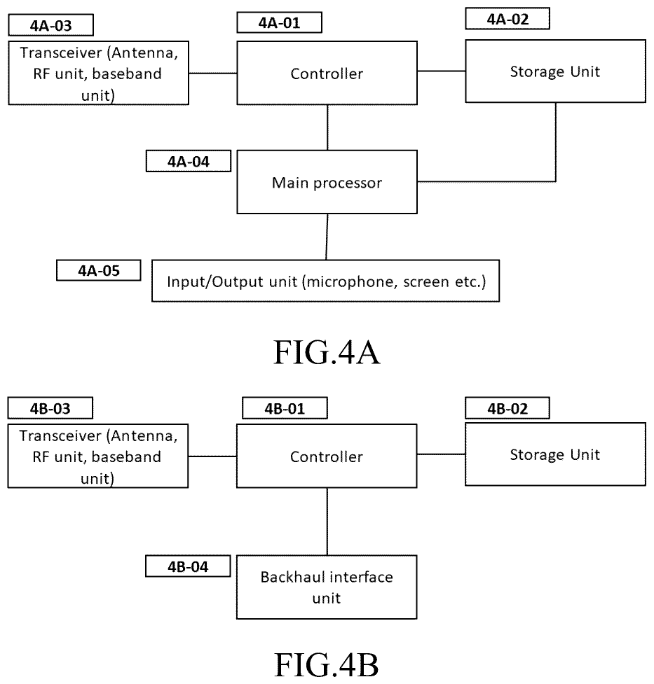

FIG. 4A is a block diagram illustrating the internal structure of a UE to which the disclosure is applied.

Referring to the diagram, the UE includes a controller 4A-01, a storage unit 4A-02, a transceiver 4A-03, a main processor 4A-04 and I/O unit 4A-05.

The controller 4A-01 controls the overall operations of the UE in terms of mobile communication. For example, the controller 4A-01 receives/transmits signals through the transceiver 4A-03. In addition, the controller 4A-01 records and reads data in the storage unit 4A-02. To this end, the controller 4A-01 includes at least one processor. For example, the controller 4A-01 may include a communication processor (CP) that performs control for communication and an application processor (AP) that controls the upper layer, such as an application program. The controller controls storage unit and transceiver such that UE operations illustrated in FIG. 2A and FIG. 3 are performed.

The storage unit 4A-02 stores data for operation of the UE, such as a basic program, an application program, and configuration information. The storage unit 4A-02 provides stored data at a request of the controller 4A-01.

The transceiver 4A-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 4A-04 controls the overall operations other than mobile operation. The main processor 4A-04 process user input received from I/O unit 4A-05, stores data in the storage unit 4A-02, controls the controller 4A-01 for required mobile communication operations and forward user data to I/O unit 4A-05.

I/O unit 4A-05 consists of equipment for inputting user data and for outputting user data such as a microphone and a screen. I/O unit 4A-05 performs inputting and outputting user data based on the main processor's instruction.

FIG. 4B is a block diagram illustrating the configuration of a base station according to the disclosure.

As illustrated in the diagram, the base station includes a controller 4B-01, a storage unit 4B-02, a transceiver 4B-03 and a backhaul interface unit 4B-04.

The controller 4B-01 controls the overall operations of the main base station. For example, the controller 4B-01 receives/transmits signals through the transceiver 4B-03, or through the backhaul interface unit 4B-04. In addition, the controller 4B-01 records and reads data in the storage unit 4B-02. To this end, the controller 4B-01 may include at least one processor. The controller controls transceiver, storage unit and backhaul interface such that base station operation illustrated in FIG. 2A are performed.

The storage unit 4B-02 stores data for operation of the main base station, such as a basic program, an application program, and configuration information. Particularly, the storage unit 4B-02 may store information regarding a bearer allocated to an accessed UE, a measurement result reported from the accessed UE, and the like. In addition, the storage unit 4B-02 may store information serving as a criterion to determine whether to provide the UE with multi-connection or to discontinue the same. In addition, the storage unit 4B-02 provides stored data at a request of the controller 4B-01.

The transceiver 4B-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 4B-04 provides an interface for communicating with other nodes inside the network. The backhaul interface unit 4B-04 converts a bit string transmitted from the base station to another node, for example, another base station or a core network, into a physical signal, and converts a physical signal received from the other node into a bit string.

What is claimed is:

1. A method by a terminal, the method comprising:
receiving by the terminal a first radio resource control (RRC) reconfiguration message, wherein the RRC reconfiguration message comprises:
a layer 1 measurement report configuration; and
one or more inner RRC reconfiguration messages;
transmitting by the terminal a layer 1 measurement report based on the layer 1 measurement report configuration;
receiving by the terminal a medium access control (MAC) control element (CE), wherein the MAC CE comprises information on one or more transmission configuration indication (TCI) states;
determining by the terminal a specific cell to apply the one or more TCI states; and
applying the one or more TCI states for the specific cell,
wherein, in case that the MAC CE is a first MAC CE:
the specific cell is determined based on a specific first identifier;
the specific first identifier is associated with a specific inner RRC reconfiguration message; and
the specific first identifier is determined based on a specific field of the first MAC CE.

2. The method of claim 1, wherein:
the specific inner RRC reconfiguration message comprises:
a special cell configuration; and
one or more secondary cell configurations.

3. The method of claim 2, wherein
the specific cell is indicated by the special cell configuration of the specific inner RRC reconfiguration message.

4. The method of claim 1, wherein in case that the MAC CE is a second MAC CE:
the specific cell is determined based on a second identifier;
the second identifier is associated with a serving cell; and
the second identifier is determined based on a second specific field of the second MAC CE

5. The method of claim 1,
wherein each of the one or more inner RRC reconfiguration message is associated with a first identifier.

6. The method of claim 5,
wherein the first MAC CE comprises:
the specific field, wherein the specific field comprises information on the first identifier; and
one or more TCI state identity fields, wherein each of the one or more TCI state identity fields comprises TCI state identity to be activated.

7. The method of claim 6, wherein:
each of the one or more TCI state identity field is associated with a first field; and
the first field indicates that TCI state identity in associated TCI state identity field is for:
downlink TCI state in case that the first field indicates a first value; and
uplink TCI state in case that the first field indicates a second value.

8. The method of claim 4,
wherein the second MAC CE comprises:
the second specific field, wherein the second specific field comprises information on the second identifier; and
one or more TCI state identity fields, wherein each of the one or more TCI state identity fields comprises TCI state identity to be activated.

9. The method of claim 8, wherein:
each of the one or more TCI state identity field is associated with a first field; and
the first field indicates TCI state identity in associated TCI state identity field is for:
downlink TCI state in case that the first field indicates a first value; and
uplink TCI state in case that the first field indicates a second value.

10. The method of claim 1, the method further comprising:
receiving by the terminal a third MAC CE, wherein the third MAC CE comprises:
a timing advance command field; and
a TCI state identity field.

11. The method of claim 10,
wherein the terminal performs lower layer triggered mobility (LTM) cell switch based on the third MAC CE.

12. The method of claim 10,
wherein TCI state indicated by the TCI state identity field is applied to LTM target cell.

13. The method of claim 10,
wherein TCI state indicated by the TCI state identity field is applied to:
a special cell of LTM candidate configuration in case that the TCI state identity field is comprised in the first MAC CE; and
the LTM target cell in case that the TCI state identity field is comprised in the third MAC CE.

14. A terminal comprising:
a transceiver,
a memory, and
a controller coupled to the transceiver and the memory, wherein the controller is configured to cause the terminal to:
receive a radio resource control (RRC) reconfiguration message, wherein the RRC reconfiguration message comprises:
a layer 1 measurement report configuration; and
one or more inner RRC reconfiguration messages;
transmit a layer 1 measurement report based on the layer 1 measurement report configuration;
receive a medium access control (MAC) control element (CE), wherein the MAC CE comprises information on one or more transmission configuration indication (TCI) states;
determine a specific cell to apply the one or more TCI states; and
apply the one or more TCI states for the specific cell,
wherein, in case that the MAC CE is a first MAC CE:
the specific cell is determined based on a specific first identifier;
the specific first identifier is associated with a specific inner RRC reconfiguration message; and
the specific first identifier is determined based on a specific field of the first MAC CE.
